(19) United States
(12) Patent Application Publication
(10) Pub. No.: US 2022/0155416 A1
(43) Pub. Date: May 19, 2022

(54) LASER EMISSION CONTROL IN LIGHT DETECTION AND RANGING (LIDAR) SYSTEMS

(71) Applicant: BEIJING VOYAGER TECHNOLOGY CO., LTD., Beijing (CN)

(72) Inventors: Wenbin Zhu, Mountain View, CA (US); An-Chun Tien, Mountain View, CA (US); Chao Wang, Mountain View, CA (US); Yonghong Guo, Mountain View, CA (US); Lingkai Kong, Mountain View, CA (US)

(73) Assignee: BEIJING VOYAGER TECHNOLOGY CO., LTD., Beijing (CN)

(21) Appl. No.: 17/097,341

(22) Filed: Nov. 13, 2020

(51) Int. Cl. G01S 7/484; G01S 7/481; G01S 17/89; G01S 17/931

(52) U.S. Cl. CPC G01S 7/484; G01S 17/931; G01S 17/89; G01S 7/4814

(57) ABSTRACT

Embodiments of the disclosure provide a system for determining a laser emitting scheme of an optical sensing device. The system includes a controller communicatively coupled to a laser emitter of the optical sensing device. The controller is configured to perform operations that includes determining a safety distance range in a field of view of the optical sensing device based on a predetermined tolerance value, causing the laser emitter to emit a first laser pulse having a first power-associated value lower than the predetermined tolerance value in the safety distance range, and detecting whether an object is detected in the safety distance range based on the first laser pulse. In response to no object being detected in the safety distance range, the controller causes the laser emitter to emit a second laser pulse having a second power-associated value higher than the first power-associated value.

### TECHNICAL FIELD

The present disclosure relates to laser emission control in Light Detection and Ranging (LiDAR) systems, and more particularly to, systems and methods for determining a multi-pulse laser emission scheme for the LiDAR systems.

### BACKGROUND

Optical sensing systems such as LiDAR systems have been widely used in autonomous driving and producing high-definition maps. For example, a typical LiDAR system measures the distance to a target by illuminating the target with pulsed laser light beams and measuring the reflected pulses with a sensor such as a photodetector. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and/or high-definition map surveys.

A LiDAR system can use a transmitter to transmits a signal (e.g., pulsed laser light) into the surroundings, and use a receiver to collect the returned signal (e.g., laser light reflected by an object in the surroundings). The LiDAR system can then calculate parameters such as the distance between the object and the LiDAR system based on, e.g., the speed of light and the time the signal travels (e.g., the duration of time between the time the signal is transmitted and the time the returned signal is received) and use the parameters to construct 3D maps and/or models of the surroundings. To improve the detection range and the signal-to-noise-ratio (SNR), higher energy of the laser light is often needed. On the other hand, however, the energy of the signal also needs to be limited to avoid potential harm to human eye. Therefore, it is challenging to balance the performance demands and regulatory safety mandate in LiDAR system development.

Embodiments of the disclosure address the above challenges by systems and methods for determining a multi-pulse laser emission scheme used in LiDAR systems to improve the detection range and SNR while complying with the safety requirements.

### SUMMARY

Embodiments of the disclosure provide a system for determining a laser emitting scheme of an optical sensing device. The system includes a controller communicatively coupled to a laser emitter of the optical sensing device. The controller is configured to perform operations that includes determining a safety distance range in a field of view of the optical sensing device based on a predetermined tolerance value, causing the laser emitter to emit a first laser pulse having a first power-associated value lower than the predetermined tolerance value in the safety distance range, and detecting whether an object is detected in the safety distance range based on the first laser pulse. In response to no object being detected in the safety distance range, the controller causes the laser emitter to emit a second laser pulse having a second power-associated value higher than the first power-associated value.

Embodiments of the disclosure also provide a method for determining a laser scanning scheme of an optical sensing device. The method includes determining a safety distance range in a field of view of the optical sensing device based on a predetermined tolerance value, causing a laser emitter of the optical sensing device to emit a first laser pulse having a first power-associated value lower than the predetermined tolerance value in the safety distance range, and detecting whether an object is detected in the safety distance range based on the first laser pulse. The method also includes, in response to no object being detected in the safety distance range, causing the laser emitter to emit a second laser pulse having a second power-associated value higher than the first power-associated value.

Embodiments of the disclosure also provide an optical sensing device that includes a laser emitter, a receiver, and a controller. The laser emitter is configured to emit laser pulses in a field of view of the optical sensing device. The receiver is configured to detect laser pulses returned from the field of view. The controller is communicatively coupled to the laser emitter and the receiver. The controller is configured to perform operations include determining a safety distance range in the field of view of the optical sensing device based on a predetermined tolerance value, causing the laser emitter to emit a first laser pulse having a first power-associated value lower than the predetermined tolerance value in the safety distance range, and detecting whether an object is detected in the safety distance range based on the first laser pulse detected by the receiver. The controller is also configured to perform an operation, in response to no object being detected in the safety distance range, causing the laser emitter to emit a second laser pulse having a second power-associated value higher than the first power-associated value.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2A illustrates a block diagram of an exemplary LiDAR system, according to embodiments of the disclosure.

FIG. 2B illustrates a block diagram of an exemplary controller for controlling laser emission in a LiDAR system, according to embodiments of the disclosure.

FIG. 3A illustrates a plurality of exemplary laser emission schemes, according to embodiments of the disclosure.

FIG. 3B illustrates calculation of a beam size of a laser beam in the detection range, according to embodiments of the disclosure.

FIG. 4 illustrates adjustment of laser emission schemes in a detection range of an exemplary LiDAR system, according to embodiments of the disclosure.

FIG. 5 illustrates a flowchart of an exemplary method to control laser emission in a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

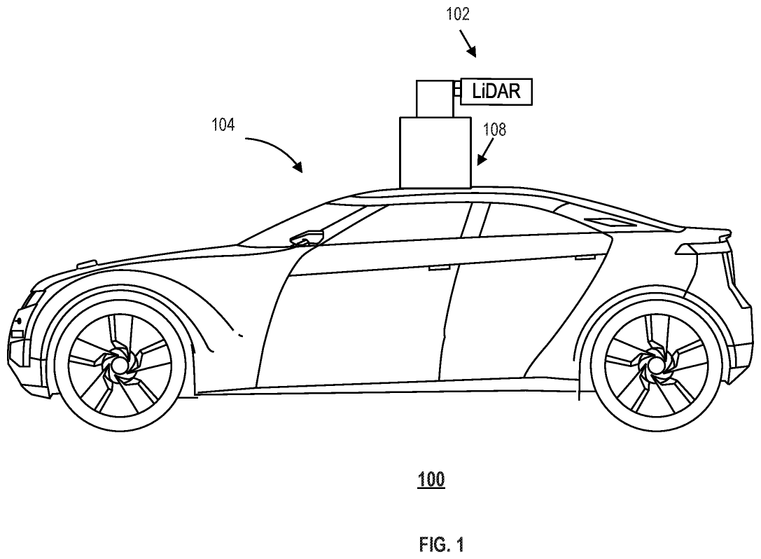

FIG. 1 illustrates a schematic diagram of an exemplary vehicle 100 equipped with a LiDAR system 102, according to embodiments of the disclosure. As illustrated in FIG. 1, vehicle 100 may be equipped with LiDAR system 102 mounted to body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. It is contemplated that the manners in which LiDAR system 102 can be equipped on vehicle 100 are not limited by the example shown in FIG. 1 and may be modified depending on the types of LiDAR system 102 and/or vehicle 100 to achieve desirable 3D sensing performance.

Consistent with some embodiments, LiDAR system 102 may be configured to capture data as vehicle 100 moves along a trajectory. For example, a transmitter of LiDAR system 102 is configured to scan the surrounding and acquire point clouds. LiDAR system 102 measures distance to a target by illuminating the target with pulsed laser light and measuring the reflected pulses with a receiver. The laser light used by LiDAR system 102 may be ultraviolet. visible. or near infrared. In some embodiments of the present disclosure, LiDAR system 102 may capture point clouds. As vehicle 100 moves along the trajectory, LiDAR system 102 may continuously emit/scan laser beams and receive returned laser beams.

Consistent with the present disclosure, a controller may be included for controlling the operation of LiDAR system 102. In some embodiments, the controller may determine laser emission scheme(s) for controlling the laser emission power in an aperture. In some embodiments, the controller may be further used for processing and/or analyzing collected data for various operations. For example, the controller may process received signals and adjust the laser emission schemes based on the processed signals. In some embodiments, the received signal is processed and the laser emission scheme(s) may be generated in real-time. A distance between the object and LiDAR system 102 may be updated in real-time for the determination of the laser emission scheme(s).

The controller may also communicate with a remote computing device, such as a server (or any suitable cloud computing system) for operations of LiDAR system 102. In some embodiments, the controller is connected to a server for processing the received signal. For example, the controller may stream the received signal to the server for data processing and receive the processed data from the server. Components of the controller may be in an integrated device or distributed at different locations but communicate with one another through a network. In some embodiments, the controller may be located entirely within LiDAR system 102. In some embodiments, one or more components of the controller may be located in LiDAR system 102, inside vehicle 100, or may be alternatively in a mobile device, in the cloud, or another remote location.

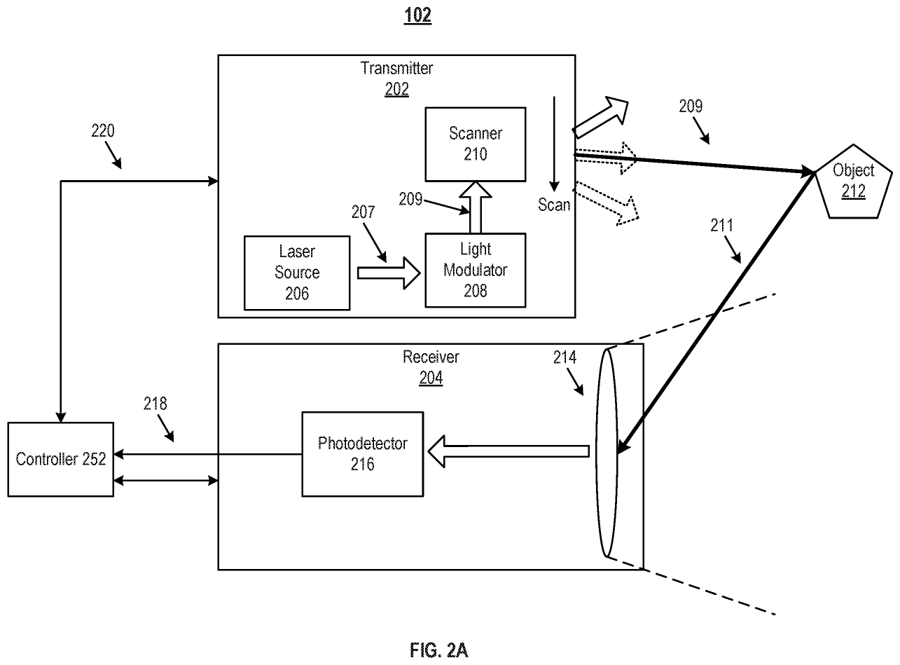

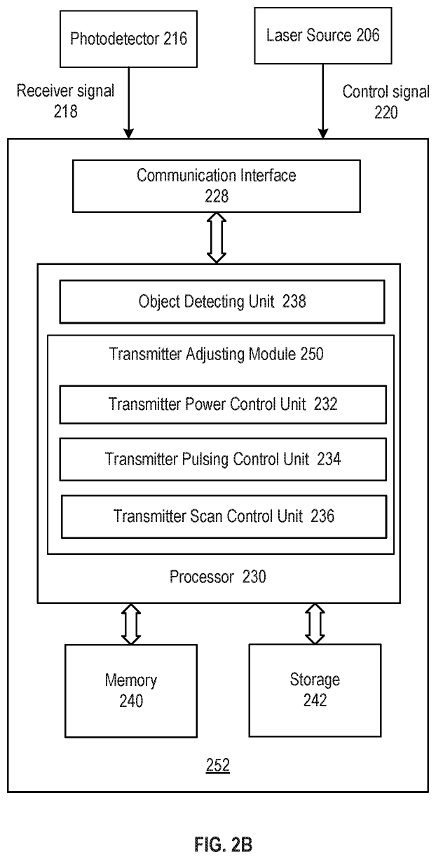

FIG. 2A illustrates a block diagram of an exemplary implementation of LiDAR system 102, according to embodiments of the disclosure. As shown in FIG. 2A, LiDAR system 102 has a transmitter 202 for emitting a laser beam 209 and a receiver 204 for collecting data that include a returned laser beam 211 reflected by an object 212. Transmitter 202 may include any suitable light source that emits laser beam 209 outwardly into the surroundings of LiDAR system 102. In some embodiments, laser beam 209 includes one or more pulsed laser signals with a scanning angle, as illustrated in FIG. 2A.

Transmitter 202 may include any suitable components for generating laser beam 209 of a desired wavelength and/or intensity. For example, transmitter 202 may include a laser source 206 that generates a native laser beam 207 in the ultraviolet, visible. or near infrared wavelength range. Transmitter 202 may also include a light modulator 208 that collimates native laser beam 207 to generate laser beam 209. Scanner 210 can scan laser beam 209 at a desired scanning angle and a desired scanning rate. Each laser beam 209 can form a scanning point on a surface facing transmitter 202 and at a distance from LiDAR system 102. Laser beam 209 may be incident on object 212, reflected back as laser beam 211, and collected by a lens 214. Object 212 may be made of a wide range of materials including, for example, live objects, non-metallic objects, rocks, rain, chemical compounds, aerosols, clouds and even single molecules. In some embodiments of the present disclosure, scanner 210 may include optical components (e.g., lenses, mirrors) that can focus pulsed laser light into a narrower laser beam to increase the scan resolution.

Receiver 204 may be configured to detect returned laser beam 211 (e.g., returned signals) reflected from object 212. Upon contact, laser light can be reflected by object 212 via backscattering. Receiver 204 can collect returned laser beam 211 and output electrical signal indicative of the intensity of returned laser beam 211. As illustrated in FIG. 2A, receiver 204 may include lens 214 and a photodetector (or photodetector array) 216. Lens 214 may be configured to collect light from a respective direction in its field of view (FOV).

Photodetector 216 may be configured to detect returned laser beam 211 reflected by object 212. Photodetector 216 may convert the laser light (e.g., returned laser beam 211) collected by lens 214 into a receiver signal 218 (e.g., a current or a voltage signal). Receiver signal 218 may be generated when photons are absorbed in photodiode 216. Receiver signal 218 may be transmitted to a data processing unit, e.g., controller 252 of LiDAR system 102, to be processed and analyzed. Controller 252 may be configured to control transmitter 202 and/or receiver 204 to perform detection/sensing operations.

Receiver signal 218 may include an electrical signal of returned laser beam 211, e.g., converted from the light signal of returned laser beam 211. Returned laser beam 211 may be caused by the reflection of laser beam 209 from object 212 in the FOV of LiDAR system 102. Receiver signal 218 may be indicative of the power of returned laser beam 211. Controller 252 may further determine the distance of object 212 from LiDAR system 102 based on the received signal. In some embodiments, controller 252 may determine subsequent laser emission scheme(s) of laser beam 209 based on the distance of object 212.

For example, to obtain a desired coverage of the surroundings and/or the resolution of the scanning/sensing result, the power of laser beam 209 can be controlled/adjusted. For example, the power of laser beam 209 needs to be sufficiently high for LiDAR system 102 to detect object 212 from a desired distance. The span of the scanning angles of laser beam 209, e.g., in the three-dimensional (3D) space, also needs to be sufficiently large to cover a desired range of the surroundings laterally and vertically. Scanner 210 may scan laser beam 209 in the 3D space along a lateral scanning direction and a vertical scanning direction, e.g., from left to the right and from top to bottom, at a desired scanning rate.

Controller 252 may be further configured to control the operations of transmitter 202 to execute the laser emission scheme(s). In some embodiments, controller 252 may adjust laser emission schemes of LiDAR system 102, e.g., in real-time, based on the ranging and detection of a desired safety distance range, and the distance of any object 212 from LiDAR system 102 determined based on receiver signal 218 and data of laser beam 209. When object 212 is close to LiDAR system 102 relatively to the detection range, using a high-power laser emission—would cause potential harm and pose safety concerns when object 212 is a human being. Accordingly, in some embodiments, controller 252 may determine no object 212 is detected in the safety distance range before emitting a laser pulse of a relatively high power for long-distance ranging and detection (e.g., of an area beyond the safety distance range). Because its beam size increases as propagation distance, the power density of the emitted laser beam may decrease when propagating at a longer distance. The laser beam can thus be safe to object 212 farther away from LiDAR system 102. In some embodiments, controller 252 may determine the safety distance range based on a power-associate value and a safety limit required by regulation. The power-associated value may reflect the total power of laser beam 209. The safety limit is a standard value defined by regulation, exceeding which the power of laser beam 209 may cause harm to the human eyes.

For example, to reduce or avoid the potential harm to human eye, controller 252 may first employ a first laser emission scheme to detect whether any object 212 is in the safety distance range. The first laser emission scheme may include a first laser pulse with power desirably low to ensure the power incident on an area representative of the size of a human eye would not exceed the safety limit. On the other hand, the power of the first laser pulse may also be sufficiently high to cover the safety distance range. Controller 252 may determine whether object 212 is present in the safety distance range by detecting the returning laser pulse within an expected time window. If object 212 is detected in the safety distance range, controller 252 may not emit any further laser pulses after the first laser pulse. Controller 252 may determine a distance between object 212 and LiDAR system 102 based on the detection of the first laser pulse returned from object 212. For example, the distance between object 212 and LiDAR system 102 may be calculated based on the speed of light, the scanning angle of laser beam 209 (e.g., the first laser pulse), the round-trip travel time of laser beam 209/211 (e.g., from transmitter 202 to object 212 and back to receiver 204), and/or the power of returned laser beam 211 (e.g., the intensity of the light signal converted by photodetector 216 to receiver signal 218).

If no object 212 is detected in the safety distance range, controller 252 may determine to execute a second laser emission scheme to range the area beyond the safety distance range. The second laser emission scheme includes a second laser pulse after the first laser pulse, and the second laser pulse has a power value higher than the power value of the first laser pulse. Controller 252 may determine the power values of the first and second laser pulses such that at any given time, the total power incident on the area representative of the size of a human eye is lower than the safety limit. With the second laser pulse, a longer-distance ranging and detection can be performed by LiDAR system 102. In some embodiments, the adjustment of laser emission scheme is performed in real-time or near real-time. Functions of controller 252 for the determination of the distance, and the adjustment of laser emission scheme of laser beam 209, are described in greater detail in connection with FIG. 2B.

FIG. 2B shows an exemplary implementation of controller 252, according to embodiments of the disclosure. Consistent with the present disclosure, controller 252 may receive receiver signal 218 (e.g., indicative of power information of returned laser beam 211) from photodetector 216.

In some embodiments, as shown in FIG. 2B, controller 252 may include a communication interface 228, a processor 230, a memory 240, and a storage 242. In some embodiments, controller 252 may have different modules in a single device, such as an integrated circuit (IC) chip (implemented as, for example, an application-specific integrated circuit (ASIC) or a field-programmable gate array (FPGA)), or separate devices with dedicated functions. In some embodiments, one or more components of controller 252 may be located in a cloud, or may be alternatively in a single location (such as inside vehicle 100 or a mobile device) or distributed locations. Components of controller 252 may be in an integrated device, or distributed at different locations but communicate with each other through a network.

Communication interface 228 may send data to and receive data from components of transmitter 202 and receiver 204 such as laser source 206 and photodetector 216 via wired communication methods, such as Serializer/Deserializer (SerDes), Low-voltage differential signaling (LVDS), Serial Peripheral Interface (SPI), etc. In some embodiments, communication interface 402 may optionally use wireless communication methods, such as a Wireless Local Area Network (WLAN), a Wide Area Network (WAN), wireless communication links such as radio waves, a cellular network, and/or a local or short-range wireless network (e.g., Bluetooth™), or other communication methods. Communication interface 228 can send and receive electrical, electromagnetic or optical signals that carry digital data streams representing various types of information.

Consistent with some embodiments, communication interface 228 may receive receiver signal 218 (e.g., containing data of returned laser beam 211). In some embodiments, communication interface 228 may sequentially receive receiver signals 218 as scanner 210 continues to scan laser beams 209 at the scanning rate. Communication interface 228 may transmit the received receiver signal 218 to processor 230 for processing.

Processor 230 may include any appropriate type of general-purpose or special-purpose microprocessor, digital signal processor, or microcontroller. Processor 230 may be configured as a stand-alone processor module dedicated to analyzing signals (e.g., receiver signal 218) and/or controlling the scan schemes. Alternatively, processor 230 may be configured as a shared processor module for performing other functions unrelated to signal analysis/scan scheme control.

In many LiDAR systems with laser wavelengths shorter than 1400 nm such as between 800 nm and 900 nm, laser energy is strictly regulated due to its potential damage to human eyes. Traditionally, the power of each laser pulse is set to be within the regulation/safety limit, based on the assumption of worst case scenario that all pulses emitted towards an eye-sized aperture is absorbed by the aperture. For high resolution and long-range LiDAR systems, this becomes a fundamental challenge. For example, long distance LiDAR requires high energy pulses, which is difficult or even impossible to achieve with the power limit set by the regulation.

The present disclosure provides systems and methods for safe ranging and detection fora long-safety distance range. A novel strategy is implemented to achieve a long detection range without violating the laser safety regulation. The LiDAR system (e.g., via the controller) may determine certain scanning parameters based on a relationship between the safety limit and the power-associated value of the laser beam to ensure power of one or more laser pulses of the laser beam satisfies the safety standards. The LiDAR system (e.g., via the controller) may also adjust the laser emission schemes based on whether an object is detected in a safety distance range (e.g., a short-safety distance range). The adjustment of laser emission schemes can ensure, if an object is detected to be in the safety distance range, a total power of a laser beam along a respective scanning direction does not exceed the safety limit. Meanwhile, if no object is detected to be in the safety distance range, the adjustment of laser emission schemes can allow the detection range beyond the safety distance range (e.g., a long-safety distance range) to be detected without violating the safety standards. The human-eye, assuming the object is a human being, is thus less susceptible to harm caused by the LiDAR system, and long-distance detection and ranging can be safely implemented. Details of the embodiments are described in greater detail as follows.

As shown in FIG. 2B, processor 230 may include multiple functional units or modules that can be implemented using software, hardware, middleware, firmware, or any combination thereof. For example, processor 230 may include an object detecting unit 238, a transmitter adjusting module 250, or the like. In some embodiments, transmitter adjusting module 250 includes a transmitter power control unit 232, a transmitter pulsing control unit 234, and a transmitter scan control unit 236. In some embodiments, based on a safety limit, processor 230 determines a safety distance range and emits a low-power laser pulse to detect any object 212 in the safety distance range. In some embodiments, the safety limit, over which potential harm can be caused to human eyes by laser beam 209, may be a predetermined tolerance value. The tolerance value can be used to determine various scanning parameters, e.g., the safety distance range and the power of the low-power laser pulse. The emission of the low-power laser pulse can ensure no harm can be caused to human eyes by laser beam 209 in the safety distance range.

Processor 230 may also adjust the laser emission scheme based on whether object 212 is detected in the safety distance range. When object 212 is not detected in the safety distance range, processor 230 may determine to emit a high-power laser pulse to detect any object 212 in the detection range beyond the safety distance range. Processor 230 may determine the power value of the high-power laser pulse so that no harm can be caused to human eyes by laser beam 209 beyond the safety distance range. When object 212 is detected in the detection range, processor 230 may determine a distance between object 212 and LiDAR 102 based on receiver signal 218 derived from the returned low-power laser pulse, and may not emit any further laser pulse after the low-power laser pulse. That is, at each scanning direction, processor 230 may avoid, in real-time, scanning potentially harmful high-power laser pulse towards object 212 based on the ranging result of the low-power laser pulse. Thus, when object 212 is a human being, the human eyes are less susceptible to harm caused by laser beam 209. In some embodiments, transmitter adjusting module 250, object detecting unit 238, and units 232-236 are configured to perform the above operations. The respective functions of transmitter adjusting module 250 and units 232-238 therein are described as follows.

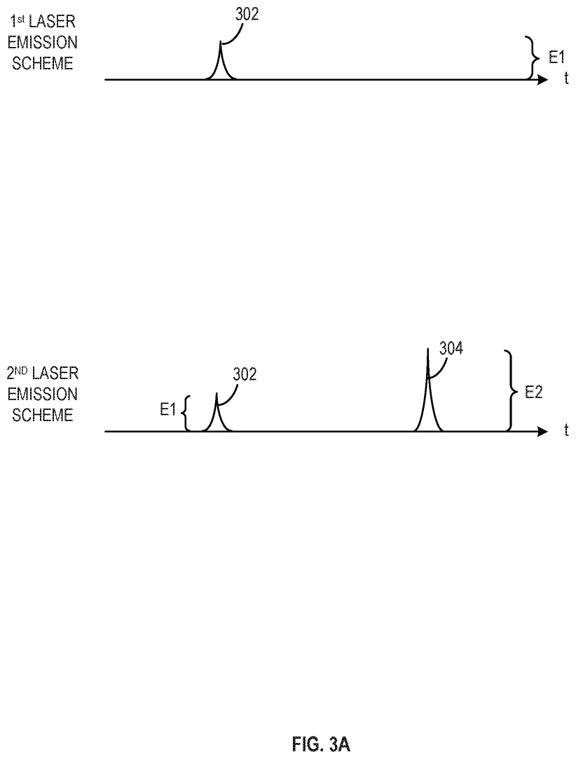

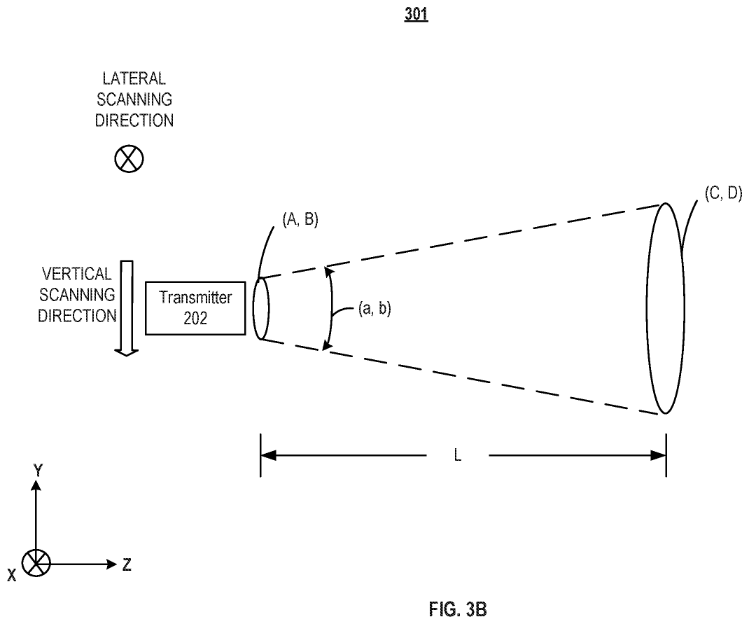

Transmitter adjusting module 250 may determine the safety distance range, a first laser emission scheme, and a second laser emission scheme. Transmitter adjusting module 250 may also determine the actual distance between object 212 and LiDAR system 102. FIG. 3A illustrates exemplary first and second laser emission schemes determined by transmitter adjusting module 250. As shown in FIG. 3A, the first laser emission scheme includes a single laser pulse (e.g., a first laser pulse 302 with a power value of E1), and the second laser emission scheme includes two laser pulses (e.g., first laser pulse 302 and a second laser pulse 304 with a power value of E2). In the second laser emission scheme, second laser pulse 304 is emitted after first laser pulse 302, and E2 may be greater than E1. First laser pulse 302 may be referred to as the low-power laser pulse, and second laser pulse 304 may be referred to as the high-power laser pulse.

Transmitter adjusting module 250 may determine the safety distance range, E1, and E2 based on the safety limit and certain power-associated values of first and second laser pulses 302 and 304. In some embodiments, the safety limit is a predetermined tolerance value such as a maximum permissible exposure (or MPE) value, which represents the highest power or energy density of a light source that is considered safe to a human eye and can be a known value. In some embodiments, the power-associated values of first and second laser pulses 302 and 304 include respective and combined power densities of first and second laser pulses 302 and 304. That is, for laser beam 209 to be safe in the detection range of LiDAR system 102, the power density on object 212, caused by laser beam 209 along a respective scanning direction, must not exceed the MPE value.

Transmitter adjusting module 250 may determine the safety distance range based on the total power density of first and second laser pulses 302 and 304 and the MPE value. By definition, the power density of laser beam 209 at a respective distance (e.g., from LiDAR system 102) may be calculated as the power of laser beam 209 divided by its beam size at the distance. Because laser beam 209 diverges in transmission, for detection range beyond the safety distance range, the beam size of laser beam 209 has its minimum value at an upper bound of the safety distance range, and continues to increase beyond the safety distance range. The upper bound may be the maximum distance of the safety distance range or the radius of the safety distance range. Accordingly, for detection range beyond the safety distance range, the total power density of first and second laser pulses 302 and 304 has its maximum value at the upper bound of the safety distance range, and decreases beyond the safety distance range.

FIG. 3B illustrates a method 301 for calculating a beam size of a laser pulse along a respective scanning direction, according to embodiments of the present disclosure. Controller 252 may control transmitter 202 to scan laser beam 209 along various directions/angles within the FOV of LiDAR system 102. In some embodiments, transmitter 202 (e.g., via scanner 210) may scan laser beam 209 along a lateral scanning direction (e.g., the x-direction) and a vertical scanning direction (e.g., the y-direction). In an example, the scanning angle of laser beam 209 may include a vertical scanning angle and a lateral scanning angle. The vertical scanning angle may represent the direction of laser beam 209 with respect to the vertical direction (e.g., the y-direction), and the lateral scanning angle may represent the direction of laser beam 209 with respect to a lateral direction (e.g., the x-direction). At a fixed lateral scanning angle, transmitter 202 may incrementally change the vertical scanning angle of laser beam 209 by a vertical delta angle so one laser beam 209 and an immediately-subsequent laser beam 209 may be separated from each other by the vertical delta angle. The vertical delta angle may be any suitable value such as 0.01°, 0.02°, 0.05°, 0.1°, 0.2°, 0.5°, 1°, and the like. In some embodiments, transmitter 202 scans laser beam 209 from top to bottom in the 3D space at each lateral scanning angle. After scanning laser beam 209 at one lateral scanning angle, transmitter 202 may scan laser beam 209 from top to bottom in the 3D space at another lateral scanning angle, which may form a lateral delta angle with the previous lateral scanning angle. The lateral delta angle may be any suitable value such as 0.01°, 0.02°, 0.05°, 0.1°, 0.2°, 0.5°, 1°, and the like.

In some embodiments, transmitter 202 repeatedly scans laser beam 209 vertically and laterally to cover the FOV of LiDAR system 102. Laser beam 209 may be emitted along its respective scanning direction within the FOV at the time it is being scanned. At any location in the FOV, on a vertical plane facing laser beam 209, the scanning pattern of laser beams 209 may form a plurality of scanning points, each scanning point corresponding to laser beam 209 scanned or to be scanned at a given time. In other words, the laser beams 209 emitted or to be emitted along a plurality of angles may project to the vertical plane to form the plurality of projections, forming the plurality of scanning points. The beam size at the location may be determined based on the diameter or width of laser beam 209 at a respective scanning point. In some embodiments, the lateral scanning angle, the vertical scanning angle, the lateral delta angles, the vertical delta angles, the scanning rate, and/or divergence characteristics of laser beam 209 may be used to determine the spatial/geometric distribution of laser beam 209 in the 3D space and the distribution of scanning points at any suitable surface/location.

As shown in FIG. 3B, assuming, at the exit of transmitter 202 (e.g., scanner 210), the laser pulse has a lateral dimension A along the x-direction and a vertical dimension B along the y-direction. As the laser pulse diverges, the beam size of the laser pulse increases as it becomes further away from the exit of transmitter 202. For example, assuming the divergence angle of the laser pulse is a mrad along the x-direction and b mrad along the y-direction, the scanning point at a distance L may have a lateral dimension of (A+a×L) mm and a vertical dimension of (B+b×L) mm. The beam size of the laser pulse at distance L may thus be calculated as S_{beam}(L)=(A+a×L)×(B+b×L). In some embodiments, A, B, a, and b may be predetermined, e.g., measured or known.

The total power density of first and second laser pulses 302 and 304 may then be equal to E_{TOT}/S_{beam}(L), where S_{beam}(L) represents the beam size of laser beam 209 at distance L and E_{TOT} represents the total power value of first and second laser pulses 302 and 304 at distance L. In various embodiments, E_{TOT} is equal to the total power value of laser beam 209 at a respective scanning direction. To determine the safety distance range, transmitter adjusting module 250 may solve the inequality of MPE≥E_{TOT}/S_{beam}(L). Often, the total power is a known value defined by the specification of LiDAR system 102. Because S_{beam}(L) is a function of L, for detection range beyond the safety distance range, S_{beam}(L) may increase as L increases. The value of E_{TOT}/S_{beam}(L) may decrease as L increases, and has its maximum value (i.e., MPE) when L is equal to its minimum value L_{MIN}. The upper bound of the safety distance range may thus be determined to be equal to or greater than L_{MIN} from LiDAR system 102.

Transmitter adjusting module 250 may determine the power value of first laser pulse 302 based on the power density of first laser pulse 302 at a threshold distance, which is a shortest viewing distance from transmitter 202 that a human eye can accommodate to. The threshold distance can be desirably close to the exit of transmitter 202 (or scanner 210) such that the power density of first laser pulse 302 at the threshold distance can be reasonably close to the power density of first laser pulse 302 at the exit of transmitter 202. Based on the safety standards, the power density value of first laser pulse 302 may not exceed the MPE value at the threshold distance. In some embodiments, according to a safety standard, transmitter adjusting module 250 determines the threshold distance to be 100 mm, and the power density of first laser pulse 302 at the threshold distance to be E1/S_{beam}(100 mm), where S_{beam}(100 mm) represents the beam size of laser beam 209 at the threshold distance of 100 mm. E1 may be equal to the product of the MPE value and S_{beam}(100 mm). As described earlier, laser beam 209 diverges in transmission, E1 is thus equal to its maximum value E1_{MAX} at the threshold distance, e.g., E1_{MAX} being equal to the product of MPE value and S_{beam}(100 mm). In some embodiments, transmitter power control unit 232 determines E1 to be a value equal to or less than E1_{MAX} . In some embodiments, E1 is sufficiently low to ensure the safety of any human eye in the safety distance range. Meanwhile, E1 may be sufficiently high to cover the safety distance range and capture data for calculating results of detection. It should be noted that, the value of the threshold distance can vary based on different safety standards. For example, according to a more restrictive safety standard, the value of the threshold distance may be longer than 100 mm, such as 150 mm. The specific value of the threshold distance should not be limited by the embodiments of the present disclosure.

Transmitter adjusting module 250 may further determine the power of second laser pulse 304 based on E_{TOT} and E1. In some embodiments, the power value of the second laser pulse, represented by E2, is calculated to be equal to (E_{TOT}−E1), in which E_{TOT} is determined by LiDAR system 102 and E1 is the power value of first laser pulse 302. In some embodiments, the power density value of the second laser pulse may or may not exceed the MPE value in the safety distance range. However, because, at a respective scanning direction, LiDAR system 102 may only emit the second laser pulse when no object 212 is detected in the safety distance range, no potential harm can be caused by the emission of the second laser pulse within the safety distance range. In the meantime, because the total power density of laser beam 209 does not exceed the MPE value in the detection range beyond the safety distance range, no potential harm can be caused by the emissions of the first and second laser pulses in the safety distance range.

Transmitter pulsing control unit 234 may execute first emission scheme by controlling transmitter 202 to emit first laser pulse 302, having power of E1. Object detecting unit 238 may determine whether any object 212 is in the safety distance range and send an alert signal to transmitter adjusting module 250 after determining that object 212 is detected in the safety distance range. For example, based on receiver signal 218, object 212 detecting unit 238 may determine, e.g., in real-time, if object 212 is detected in the detection range, object detecting unit 238 may calculate a distance between object 212 and LiDAR system 102, and compare the distance with the upper bound of the safety distance range. Object detecting unit 238 may then determine whether object 212 is in the safety distance range. When no object 212 is detected in the safety distance range, object detecting unit 238 may send an alert signal to transmitter adjusting module 250 so that transmitter pulsing control unit 234 may switch from the first laser emission scheme to the second laser scheme. In some embodiments, transmitter pulsing control unit 234 controls transmitter 202 to emit second laser pulse 304, having a power of E2. Transmitter power control unit 232 may adjust the power of scanner 210 for the emission of first and second laser pulses 302 and 304.

In some embodiments, when object detecting unit 238 determines that the distance between LiDAR system 102 and object 212 is equal to or less than the upper bound of the safety distance range, object detecting unit 238 determines object 212 is in the safety distance range. Object detecting unit 238 may send another alert signal to transmitter adjusting module 250. Transmitter pulsing control unit 234 may determine to maintain the first emission scheme such that no laser pulse is emitted after first laser pulse 302. Thus, object 212, in the safety distance range, is less susceptible to (or free of) potential harm caused by laser beam 209. Meanwhile, object detecting unit 238 may determine the distance between object 212 and LiDAR system 102 based on, e.g., the round-trip travel time of laser beams 209 and 211 and the scanning angle of scanner 210. In some embodiments, after the emission of second laser pulse 304, object detecting unit 238 determines the distance between object 212 and LiDAR system 102 based on the second laser pulse if object 212 is detected beyond safety distance range.

In some embodiments, transmitter scan control unit 236 controls the scanning of various scanning points along a vertical direction and a horizontal direction. Transmitter scan control unit 236 may control scanner 210 to move to the next scanning direction after the scanning of a respective scanning direction is completed. Transmitter scan control unit 235 may provide data of the scanning, such as scanning angle and divergence angle of laser beam 209, for the calculation of, e.g., the beam size at any distance from LiDAR system 102 and the distance between object 212 and LiDAR system 102.

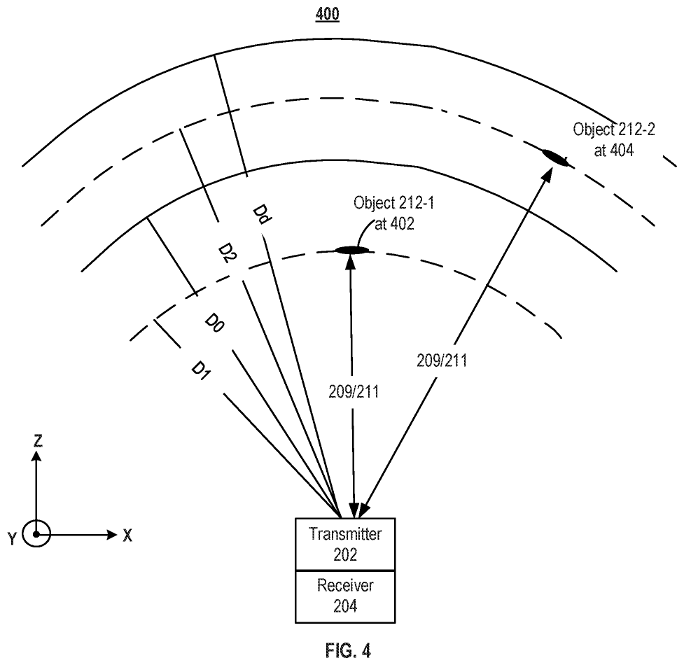

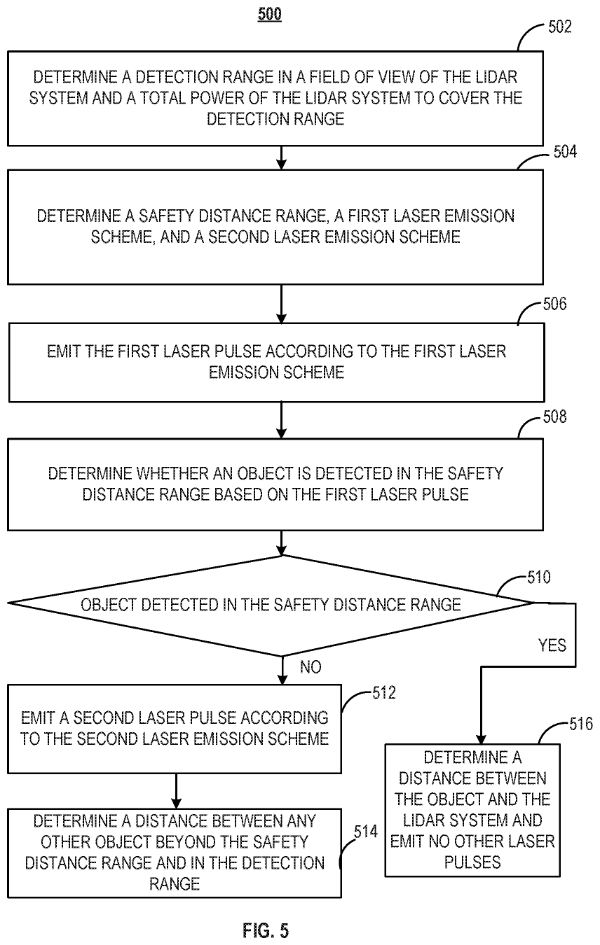

Units 232-238 (and any corresponding sub-modules or sub-units) and module 250 can be hardware units (e.g., portions of an integrated circuit) of processor 230 designed for operation independently or with other components or software units implemented by processor 230 through executing at least part of a program. The program may be stored on a computer-readable medium. When the program is executed by processor 230, the executed program may cause processor 230 to perform one or more functions or operations. Although FIG. 2B shows units 232-238 all within one processor 230, it is contemplated that these units may be distributed among multiple processors located close to or remotely with each other. The functions of units 232-236 and module 250 are described in greater detail as follows in connection with FIGS. 4 and 5.

Memory 240 and storage 242 may include any appropriate type of mass storage provided to store any type of information that processor 230 may need to operate. Memory 240 and/or storage 242 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, a static RAM, a hard disk, an SSD, an optical disk, etc. Memory 240 and/or storage 242 may be configured to store one or more computer programs that may be executed by processor 230 to perform functions disclosed herein. For example, memory 240 and/or storage 242 may be configured to store program(s) that may be executed by processor 230 to analyze LiDAR signals and control the emission schemes of laser beams.

Memory 240 and/or storage 242 may be further configured to store/cache information and data received and/or used by processor 230. For instance, memory 240 and/or storage 242 may be configured to store/cache receiver signal 218, data of laser beam 209, predetermined tolerance value(s), look-up tables storing mapping relationship between values indicating the total power incident to a unit area/size at various distances and the corresponding tolerance values indicating the safety limits, and calculation results obtained by different units of processor 230. The various types of data may be stored permanently, removed periodically, or disregarded immediately after each frame of data is processed.

FIG. 4 illustrates an exemplary FOV 400 of LiDAR system 102, according to embodiments of the present disclosure. FIG. 5 illustrates a flow chart of an exemplary method 500 for controlling the laser emission scheme of laser beam 209, according to some embodiments. For ease of illustration, method 500 is described with FIGS. 3A, 3B and 4, and the adjustment of laser emission scheme is used as an example to describe method 500.

As shown in FIG. 5, at step 502, a detection range of a field of view (FOV) of LiDAR system 102 and a total power of a laser beam emitted by the LiDAR system to cover the detection range are determined. As shown in FIG. 4, controller 252 may determine a detection range and a total power that can be emitted by LiDAR system 102. The detection range may represent an area with a radius of Dd from LiDAR system 102. That is, the upper bound of the detection range is Dd from LiDAR 102 system. In some embodiments, controller 252 determines the detection range based on the total power value of laser beam 209, i.e., E_{TOT}. In some embodiments, at a respective scanning direction, E_{TOT} may not exceed the total power emitted by transmitter 202. In some embodiments, controller 252 determines E_{TOT} to be equal to the total power that can be emitted by LiDAR system 102 at a respective scanning direction, e.g., to maximize the detection range. In other embodiments, controller 252 determines E_{TOT} to be less than the total power that can be emitted by LiDAR system 102.

Referring back to FIG. 5, at step 504, a safety distance range, a first laser emission scheme, and a second laser emission scheme are respectively determined. Referring back to FIG. 4, the safety distance range may be less than the detection range. The safety distance range may represent an area with a radius of D0 from LiDAR system 102. That is, the upper bound of the safety distance range is D0 (D0<Dd) from LiDAR 102 system. As described above, controller 252 may determine the value of D0 based on a predetermined tolerance value, e.g., MPE value, and the total power density value that can be caused by laser beam 209. As described earlier, controller 252 may determine a minimum value L_{MIN} for the upper bound of the safety distance range, and further determine D0 to be a value greater than L_{MIN} and less than Dd.

Controller 252 may also determine the first and second laser emission schemes, e.g., as shown in FIG. 3A. In some embodiments, the first laser emission scheme includes first laser pulse 302 as the single laser pulse. In some embodiments, the second laser emission scheme includes first laser pulse 302 and second laser pulse 304 after first laser pulse 302. The determination of the first and second laser emission schemes may include the determination of power E1 of first laser pulse 302 and power E2 of second laser pulse 304.

Referring back to FIG. 5, at step 506, a first laser pulse is emitted according to the first laser emission scheme. As shown in FIG. 4, controller 252 may control transmitter 202 (e.g., scanner 210) to emit first laser pulse 302, at a respective scanning direction according to the first laser emission scheme.

Referring back to FIG. 5, at step 508, it is determined whether an object is detected in the safety distance range based on the first laser pulse. Controller 252 may determine whether object 212 is in the safety distance range based on returned laser beam 211 of laser beam 209 (e.g., first laser pulse 302). If object 212 is located in the detection range, first laser pulse 302 may be reflected, forming returned laser beam 211 containing the reflected laser pulse from object 212. Returned laser beam 211 may then be detected by photodetector 216 and converted to the respective receiver signal 218, which is further transmitted to controller 252 for processing.

At step 510, if no object is detected in the safety distance range, method 500 proceeds to step 512, in which second laser pulse 304 is emitted along the respective scanning direction according to the second laser emission scheme. In some embodiments, controller 252 may execute the second laser emission scheme when no object 212 is detected in the safety distance range. Second laser pulse may have a power value of E2 that is higher than E1, and can be used for detection and ranging in the area beyond the safety distance range and in the detection range of LiDAR system 102, e.g., between the bounds of D0 and Dd.

Referring back FIG. 5, at step 514, controller employs the second laser pulse to determine a distance between any other object beyond the safety distance range and in the detection range. Referring back to FIG. 4, controller 252 may process receiver signal 218 formed by returned laser beam 211 of second pulse 304. If object 212-2 is detected at a location 404 beyond the safety distance range and in the detection range, controller 252 may determine a distance D2 between object 212-1 and LiDAR system 102. In some embodiments, controller 252 may, after the receipt of returned laser beam 211, control transmitter 202 (e.g., scanner 210 therein) to start scanning the next scanning direction.

At step 510, if an object is detected in the safety distance range, method 500 proceeds to step 516, in which a distance between the object and the LIDAR system is determined and no other laser pulses are emitted in the scanning direction. As shown in FIG. 4, controller 252 may determine a distance D1 between any object 212 detected in the detection range and LiDAR system 102 based on returned laser beam 211 resulted from the reflection of first laser pulse 302. If distance D1 between LiDAR system 102 and an object 212-1 at a location 402 is less than DO, controller 252 may determine object 212-1 to be in the safety distance range.

Referring back to FIG. 5, at step 516, controller 252 may store and provide D1 for processing, or output to a user as an indication. In the meantime, along the respective scanning direction, controller 252 may maintain the first laser emission scheme such that no other laser pulses are emitted after first laser pulse 302. Controller 252 may controller transmitter 202 (or scanner 210) to start scanning the next scanning direction.

In various embodiments, controller 252 may perform at least part of method 500 for each scanning direction during the scanning of the FOV. In some embodiments, controller 252 perform method 500, repeatedly, for each scanning direction. In some embodiments, steps 502 and 504 may be performed once to determine the same safety distance range, and the same first and second laser pulses for each respective scanning direction. In some embodiments, at least steps 506-516 are performed for the respective scanning direction. In some other embodiments, steps 502-516 are performed at least for a plurality of scanning directions. For example, controller 252 may determine different values of E_{TOT} for different safety distance ranges, as long as the value of E_{TOT} does not exceed the total power that can be emitted by LiDAR system 102.

It is also noted that, the predetermined tolerance value used in the calculation of various scanning parameters in this disclosure may also be in forms other than MPE. For example, instead of the MPE value, the predetermine tolerance value may be an accessible emission limit (AEL) value for Class 1, which represents the maximum accessible emission level permitted under normal use and is determined as a product of the MPE value times an area factor called the limiting aperture. In the present disclosure, the AEL value may reflect the total power of laser beam 209 received by a calibration detector (e.g., a photodetector, a meter, or the like) along a respective scanning direction during a measurement setup of a laser safety setup, and may be greater than or equal to E_{TOT}×S_{detector}/S_{beam}(L), where S_{detector} represents the area of the calibration detector and S_{beam}(L) represents the beam size at distance L. The power-associated values, in this case, may include power values of the first and second laser pulses, respectively, instead of the respective power density values. The equality of AEL may also be used, e.g., as an alternative, to calculate the upper bound (e.g., radius) of the safety distance range.

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for determining a laser emitting scheme of an optical sensing device, the system comprising:
a controller communicatively coupled to a laser emitter of the optical sensing device, the controller configured to perform operations comprising:
determining a safety distance range in a field of view of the optical sensing device based on a predetermined tolerance value;
causing the laser emitter to emit a first laser pulse having a first power-associated value lower than the predetermined tolerance value in the safety distance range;
detecting whether an object is detected in the safety distance range based on the first laser pulse; and
in response to no object being detected in the safety distance range, causing the laser emitter to emit a second laser pulse having a second power-associated value higher than the first power-associated value.

2. The system of claim 1, wherein the first power-associated value is a power density value of the first laser pulse, and the second power-associated value is a power density value of the second laser pulse.

3. The system of claim 2, wherein the operations comprise:
determining a detection range of the optical sensing device, the detection range being greater than the safety distance range;
determining a total power value of the optical sensing device;
determining a first power value of the first laser pulse; and
determining a second power value of the second laser pulse based on the first power value and the total power value.

4. The system of claim 3, wherein determining the first power value comprises:
determining a beam size of the first laser pulse at a threshold distance;
determining a maximum value of the first power value to be equal to a product of the predetermined tolerance value and the beam size of the first laser pulse at the threshold distance; and
determining the first power value to be lower than or equal to the maximum value of the first power value.

5. The system of claim 3, wherein determining the second power value comprises deducting the first power value from the total power value.

6. The system of claim 2, wherein determining the safety distance range further comprises:
determining a total power value of the optical sensing device; and
determining a beam size of a laser pulse as a function of distance along a scanning direction; and
determining an upper bound of the safety distance range such that a ratio of the total power value over the beam size at the upper bound of the safety distance range is equal to or less than the predetermined tolerance value.

7. The system of claim 1, wherein the operations further comprise determining a total power-associated value of the first laser pulse and the second laser pulse to be lower than or equal to the predetermined tolerance value beyond the safety distance range.

8. The system of claim 7, wherein determining the total power-associated value of the first laser pulse and the second laser pulse comprises determining a total power density value of the first laser pulse and the second laser pulse.

9. The system of claim 1, wherein the operations further comprise:
in response to the object being detected in the safety distance range, determining a distance between the object and the optical sensing device based on the first laser pulse.

10. The system of claim 1, wherein the operations further comprise:
in response to the object being detected in the safety distance range, causing the laser emitter not to emit the second laser pulse.

11. The system of claim 1, wherein the operations further comprise:
determining whether an object is detected beyond the safety distance range based on the second laser pulse; and
determining a distance between the object and the optical sensing device.

12. A method for determining a laser scanning scheme of an optical sensing device, the method comprising:
determining a safety distance range in a field of view of the optical sensing device based on a predetermined tolerance value;
causing a laser emitter of the optical sensing device to emit a first laser pulse having a first power-associated value lower than the predetermined tolerance value in the safety distance range;
detecting whether an object is detected in the safety distance range based on the first laser pulse; and
in response to no object being detected in the safety distance range, causing the laser emitter to emit a second laser pulse having a second power-associated value higher than the first power-associated value.

13. The method of claim 12, comprising determining the first power-associated value to be a power density value of the first laser pulse, and the second power-associated value to be a power density value of the second laser pulse.

14. The method of claim 13, wherein the method further comprises:
determining a total power density value of the first laser pulse and the second laser pulse to be lower than or equal to the predetermined tolerance value beyond the safety distance range.

15. The method of claim 13, wherein the operations comprise:
determining a detection range of the optical sensing device, the detection range being greater than the safety distance range;
determining a total power value of the optical sensing device;
determining a first power value of the first laser pulse; and
determining a second power value of the second laser pulse based on the first power value and the total power value.

16. The method of claim 15, wherein determining the first power value comprises:
determining a beam size of the first laser pulse at a threshold distance value;
determining a maximum value of the first power value to be equal to a product of the predetermined tolerance value and the beam size of the first laser pulse at the threshold distance value; and
determining the first power value to be lower than or equal to the maximum value of the first power value.

17. The method of claim 15, wherein determining the second power value comprises deducting the first power value from the total power value.

18. The method of claim 13, wherein determining the safety distance range comprises:
determining a total power value of the optical sensing device; and
determining a beam size of a laser pulse as a function of distance along a scanning direction; and
determining an upper bound of the safety distance range such that a ratio of the total power value over the beam size at the upper bound of the safety distance range is equal to or less than the predetermined tolerance value.

19. The method of claim 12, wherein the operations further comprise, in response to the object being detected in the safety distance range, determining a distance between the object and the optical sensing device based on the first laser pulse; and
causing the laser emitter not to emit the second laser pulse.

20. An optical sensing device, comprising:
a laser emitter configured to emit laser pulses in a field of view of the optical sensing device;
a receiver configured to detect laser pulses returned from the field of view; and
a controller communicatively coupled to the laser emitter and the receiver, the controller configured to perform operations comprising:
determining a safety distance range in the field of view of the optical sensing device based on a predetermined tolerance value;
causing the laser emitter to emit a first laser pulse having a first power-associated value lower than the predetermined tolerance value in the safety distance range;
detecting whether an object is detected in the safety distance range based on the first laser pulse detected by the receiver; and
in response to no object being detected in the safety distance range, causing the laser emitter to emit a second laser pulse having a second power-associated value higher than the first power-associated value.
